(19) United States
(12) Patent Application Publication
(10) Pub. No.: US 2019/0130913 A1
(43) Pub. Date: May 2, 2019

(54) SYSTEM AND METHOD FOR REAL-TIME TRANSCRIPTION OF AN AUDIO SIGNAL INTO TEXTS

(71) Applicant: BEIJING DIDI INFINITY TECHNOLOGY AND DEVELOPMENT CO., LTD., Beijing (CN)

(72) Inventor: Shilong LI, Beijing (CN)

(73) Assignee: BEIJING DIDI INFINITY TECHNOLOGY AND DEVELOPMENT CO., LTD., Beijing (CN)

(21) Appl. No.: 16/234,042

(22) Filed: Dec. 27, 2018

Related U.S. Application Data
(63) Continuation of application No. PCT/CN2017/081659, filed on Apr. 24, 2017.

(51) Int. Cl. G10L 15/26; G10L 15/22; G10L 15/30

(52) U.S. Cl. CPC G10L 15/26; G10L 15/30; G10L 15/22

(57) ABSTRACT

Systems and methods for real-time transcription of an audio signal into texts are disclosed, wherein the audio signal contains a first speech signal and a second speech signal. The method may include establishing a session for receiving the audio signal, receiving the first speech signal through the established session, segmenting the first speech signal into a first set of speech segments, transcribing the first set of speech segments into a first set of texts, and receiving the second speech signal while the first set of speech segments are being transcribed.

### CROSS-REFERENCE TO RELATED APPLICATION

This application is a Continuation of International Application No. PCT/CN2017/081659, filed on Apr. 24, 2018, the contents of which is incorporated herein by reference.

### TECHNICAL FIELD

The present disclosure relates to speech recognition, and more particularly, to systems and methods for transcribing an audio signal, such as a speech, into texts and distributing the texts to subscribers in real time.

### BACKGROUND

Automatic Speech Recognition (ASR) systems can be used to transcribe a speech into texts. The transcribed texts may be subscribed by a computer program or a person for further analysis. For example, ASR transcribed texts from user calls may be utilized by a call center of an online hailing platform, so that the calls may be more efficiently analyzed to improve the efficiency for dispatching taxis or private cars to the user.

Conventional ASR systems require the whole speech to be received before the speech recognition can be performed to generate transcribed texts. Therefore, transcription of a long speech can hardly be performed in real time. For example, ASR systems of the online hailing platform may keep recording the call until it is over, and then start to transcribe the recorded call.

Embodiments of the disclosure provide an improved transcription system and method that transcribes a speech into texts and distributes the texts to subscribers in real time.

### SUMMARY

In one aspect, the disclosure is directed to a method for transcribing an audio signal into texts, wherein the audio signal contains a first speech signal and a second speech signal. The method may include establishing a session for receiving the audio signal, receiving the first speech signal through the established session, segmenting the first speech signal into a first set of speech segments, transcribing the first set of speech segments into a first set of texts, and receiving the second speech signal while the first set of speech segments are being transcribed.

In another aspect, the disclosure is directed to a speech recognition system for transcribing an audio signal into speech texts, wherein the audio signal contains a first speech signal and a second speech signal. The speech recognition system may include a communication interface configured for establishing a session for receiving the audio signal and receiving the first speech signal through the established session, a segmenting unit configured for segmenting the first speech signal into a first set of speech segments, and a transcribing unit configured for transcribing the first set of speech segments into a first set of texts, wherein the communication interface is further configured for receiving the second speech signal while the first set of speech segments are being transcribed.

In another aspect, the disclosure is directed to a non-transitory computer-readable medium. Computer instructions stored on the computer-readable medium, when executed by a processor, may perform a method for transcribing an audio signal into texts, wherein the audio signal contains a first speech signal and a second speech signal. The method may include establishing a session for receiving the audio signal, receiving the first speech signal through the established session, segmenting the first speech signal into a first set of speech segments, transcribing the first set of speech segments into a first set of texts, and receiving the second speech signal while the first set of speech segments are being transcribed.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of a speech recognition system, according to some embodiments of the disclosure.

FIG. 2 illustrates an exemplary connection between a speech source and a speech recognition system, according to some embodiments of the disclosure.

FIG. 3 illustrates a block diagram of a speech recognition system, according to some embodiments of the disclosure.

FIG. 4 is a flowchart of an exemplary process for transcribing an audio signal into texts, according to some embodiments of the disclosure.

FIG. 5 is a flowchart of an exemplary process for distributing transcribed texts to a subscriber, according to some embodiments of the disclosure.

FIG. 6 is a flowchart of an exemplary process for transcribing an audio signal into texts, according to some embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

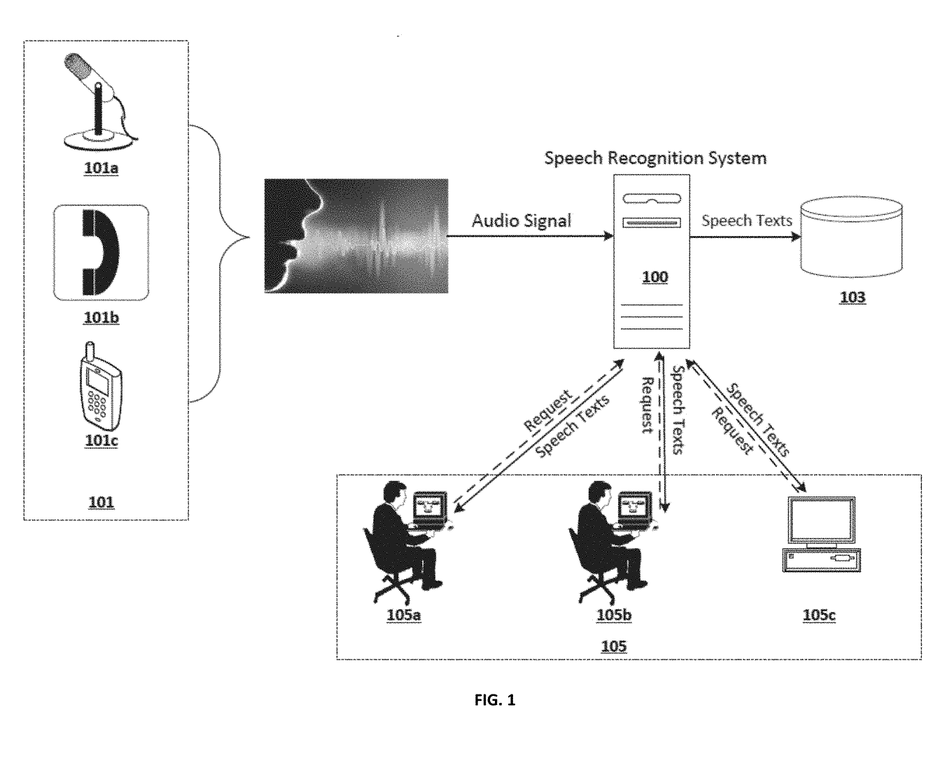

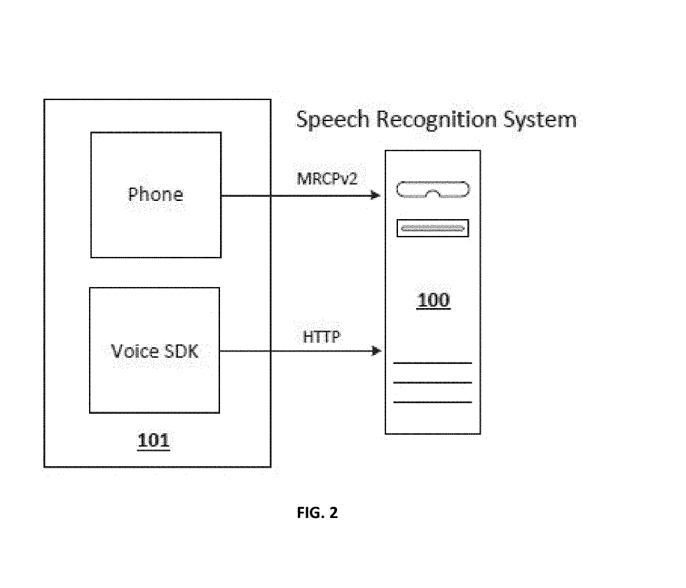

FIG. 1 illustrates a schematic diagram of a speech recognition system, according to some embodiments of the disclosure. As shown in FIG. 1, speech recognition system 100 may receive an audio signal from a speech source 101 and transcribe the audio signal into speech texts. Speech source 101 may include a microphone 101a, a phone 101b, or an application on a smart device 101c (such as a smart phone, a tablet, or the like) that receives and records an audio signal, such as a record of a phone call. FIG. 2 illustrates an exemplary connection between speech source 101 and speech recognition system 100, according to some embodiments of the disclosure.

In one embodiment, a speaker may give a speech at a meeting or a lecture, and the speech may be recorded by microphone 101b. The speech may be uploaded to speech recognition system 100 in real time or after the speech is finished and completely recorded. The speech may then be transcribed by speech recognition system 100 into speech texts. Speech recognition system 100 may automatically save the speech texts and/or distribute the speech texts to subscribers.

In another embodiment, a user may use phone 101b to make a phone call. For example, the user may call the call center of an online hailing platform, requesting a taxi or a private car. As shown in FIG. 2, the online hailing platform may support Media Resource Control Protocol version 2 (MRCPv2), a communication protocol used by speech servers (e.g., servers at the online hailing platform) to provide various services to clients. MRCPv2 may establish a control session and audio steams between the clients and the server by using, for example, the Session Initiation Protocol (SIP) and the Real-Time Protocol (RTP). That is, audio signals of the phone call may be received in real time by speech recognition system 100 according to MRCPv2.

The audio signals received by speech recognition system 100 may be pre-processed before being transcribed. In some embodiments, original formats of audio signals may be converted into a format that is compatible with speech recognition system 100. In addition, a dual-audio-track recording of the phone call may be divided into two single-audio-track signals. For example, multimedia framework FFmpeg may be used to convert a dual-audio-track recording into two single-audio-track signals in the Pulse Code Modulation (PCM) format.

In yet another embodiment, a user may, through mobile applications (such as a DiDi app) on smart device 101c, record a voice message, or perform voice chat with the customer service of the online hailing platform. As shown in FIG. 2, the mobile application may contain a voice Software Development Kit (SDK) for processing audio signals of the voice message or the voice chat, and the processed audio signals may be transmitted to speech recognition system 100 of the online hailing platform according to, for example, the HyperText Transfer Protocol (HTTP). The SDK of the application may further compress the audio signals into an audio file in the Adaptive Multi-Rate (amr) or Broad Voice 32 (bv32) format.

With reference back to FIG. 1, the transcribed speech texts may be stored in a storage device 103, so that the stored speech texts may be later retrieved and further processed. Storage device 103 may be internal or external to speech recognition system 100. Storage device 103 may be implemented as any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, or a magnetic or optical disk.

Speech recognition system 100 may also distribute the transcribed texts to one or more subscribers 105, automatically or upon request. Subscribers 105 may include a person who subscribes to the texts or a device (including a computer program) that is configured to further process the texts. For example, as shown in FIG. 1, subscribers 105 may include a first user 105a, a second user 105b, and a text processing device 105c. The subscribers may subscribe the transcribed texts at different time points, which will be further discussed.

In some embodiments, a speech may be a long speech that lasts for a while, and the audio signal of the speech may be transmitted to speech recognition system 100 in segments while the speech is still ongoing. The audio signal may contain a plurality of speech signals, and the plurality of speech signals may be transmitted in sequence. In some embodiments, a speech signal may represent a part of the speech during a certain time period, or a certain channel of the speech. It is contemplated that a speech signal may also be any type of audio signal that represents transcribable content, such as a phone conversion, a movie, a TV episode, a song, a news report, a presentation, a debate, or the like. For example, the audio signal may include a first speech signal and a second speech signal, and the first and second speech signals can be transmitted in sequence. The first speech signal corresponds to a first part of the speech, and the second speech signal corresponds to a second part of the speech. As another example, the first and second speech signals, respectively, correspond to content of the left and right channels of the speech.

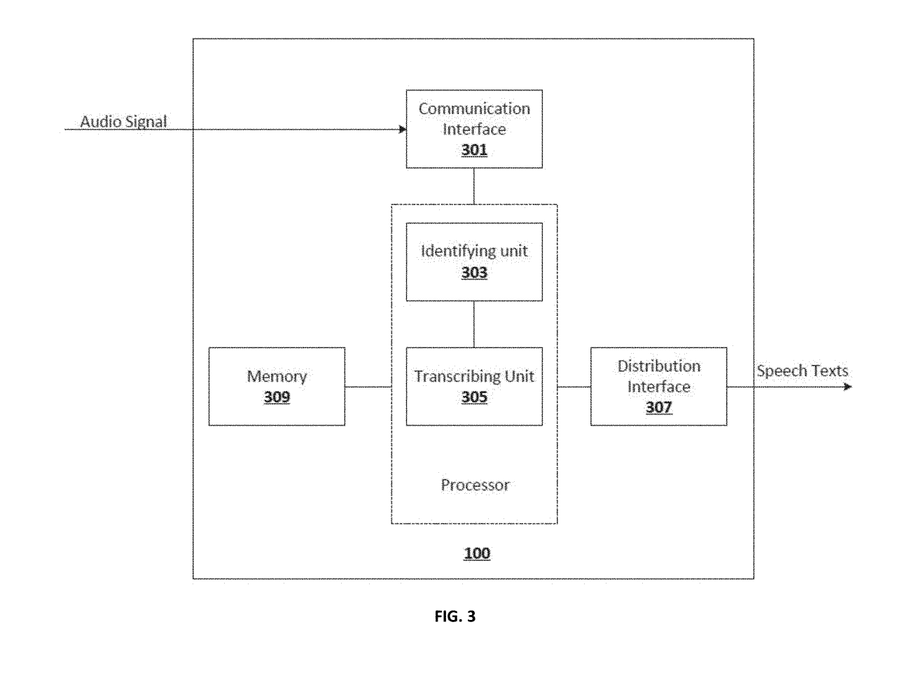

FIG. 3 illustrates a block diagram of speech recognition system 100, according to some embodiments of the disclosure.

Speech recognition system 100 may include a communication interface 301, an identifying unit 303, a transcribing unit 305, a distribution interface 307, and a memory 309. In some embodiments, identifying unit 303 and transcribing unit 305 may be components of a processor of speech recognition system 100. These modules (and any corresponding sub-modules or sub-units) can be functional hardware units (e.g., portions of an integrated circuit) designed for use with other components or a part of a program (stored on a computer readable medium) that performs a particular function.

Communication interface 301 may establish a session for receiving the audio signal, and may receive speech signals (e.g., the first and second speech signals) of the audio signal through the established session. For example, a client terminal may send a request to communication interface 301, to the establish the session. When the session is established according to MRCPv2 and SIP, speech recognition system 100 may identify an SIP session by tags (such as a “To” tag, a “From” tag, and a “Call-ID” tag). When the session is established according to the HTTP, speech recognition system 100 may assign the session with a unique token generated by the Universally Unique Identifier (UUID). The token for the session may be released after the session is finished.

Communication interface 301 may monitor a packet loss rate during the transmission of the audio signal. Packet loss rate is an indication of network connection stability. When the packet loss rate is greater than a certain value (e.g., 2%), it may suggest that the network connection between speech source 101 and speech recognition system 100 is not stable, and the received audio signal of the speech may have lost too much data for any reconstruction or further analysis to be possible. Therefore, communication interface 301 may terminate the session when the packet loss rate is greater than a predetermined threshold (e.g., 2%), and report an error to speech source 101. In some embodiments, after the session is idle for a predetermined period of time (e.g., 30 seconds), speech recognition system 100 may determine the speaker has finished the speech, and communication interface 301 may then terminate the session. It is contemplated that, the session may also be manually terminated by speech source 101 (i.e., the speaker).

Communication interface 301 may further determine a time point at which each of the speech signals is received. For example, communication interface 301 may determine a first time point at which the first speech signal is received and a second time point at which the second speech signal is received.

The audio signal received by communication interface 301 may be further processed before being transcribed by transcribing unit 305. Each speech signal may contain several sentences that are too long for voice recognition system 100 to transcribe at once. Thus, identifying unit 303 may segment the received audio signal into speech segments. For example, the first and second speech signals of the audio signal may be further segmented into first and second sets of speech segments, respectively. In some embodiments, Voice Activity Detection (VAD) may be used for segmenting the received audio signal. For example, VAD may divide the first speech signal into speech segments corresponding to sentences or words. VAD may also identify the non-speech section of the first speech signal, and further exclude the non-speech section from transcription, saving computation and throughput of the system. In some embodiments, the first and second speech signals may be combined into a long speech signal back-to-back, which may be then segmented.

Transcribing unit 305 may transcribe speech segments for each of the speech signals into a set of texts. For example, the first and second sets of speech segments of the first and second speech signals may be transcribed into first and second sets of texts, respectively. The speech segments may be transcribed in sequence or in parallel. In some embodiments, Automatic speech recognition (ASR) may be used to transcribe the speech segments, so that the speech signal may be stored and further processed as texts.

Other than merely translating the audio signal into texts, transcribing unit 305 may further identify the identity of the speaker if the specific voice of the speaker has been stored in the database of the system. The transcribed texts and the identity of the speaker may be transmitted back to identifying unit 303 for further processing.

Furthermore, for example, when a user calls the online hailing platform, speech recognition system 100 may transcribe the audio signal of the phone call and further identify the identity of the user. Then, identifying unit 303 of speech recognition system 100 may identify key words in the transcribed texts, highlight the key words, and/or provide extra information associated with the key words to customer service of the online hailing platform. In some embodiments, when key words for a departure location and a destination location of a trip are detected in the transcribed texts, possible routes of the trip and time for each route may be provided. Therefore, the customer service may not need to collect the associated information manually. In some embodiments, information associated with the user, such as his/her preference, historical orders, frequently-used destinations, or the like may be identified and provided to the customer service of the platform.

While the first set of speech segments of the first speech signal is being transcribed by transcribing unit 305, communication interface 301 may continue to receive the second speech signal. For each of the speech signals (e.g., the first and second speech signals), a thread may be established during the session. For example, the first speech signal may be received via a first thread, and the second speech signal may be received via a second thread. When the transmission of first speech signal is complete, a response may be generated for releasing the first thread and identifying unit 303 and transcribing unit 305 may start to process the received signal. In the meanwhile, the second thread may be established for receiving the second speech signal. Similarly, when the second speech signal is completely received and sent off for transcription, communication interface 301 of speech recognition system 100 may establish another thread to receive another speech signal.

Therefore, processing a received speech signal may be performed while another incoming speech signal is being received, without having to wait for the entire audio signal to be received before transcription can commence. This feature may enable speech recognition system 100 to transcribe the speech in real time.

Although identifying unit 303 and transcribing unit 305 are illustrated as separated processing units, it is contemplated that units 303 and 305 may also be functional components of a processor.

Memory 309 may combine the speech texts of the speech signals in sequence and store the combined texts as an addition to the transcribed texts. For example, the first and second sets of texts may be combined and stored. Furthermore, memory 309 may store the combined texts according to the time points determined by communication interface 301, which indicate when the speech signals corresponding to the combined texts are received.

Besides receiving the speech signals of the audio signal, communication interface 301 may further receive from a subscriber a first request for subscribing to the transcribed texts of the audio signal and determine a time point at which the first request is received. Distribution interface 307 may distribute to the subscriber a subset of the transcribed texts corresponding to the time point determined by communication interface 301. In some embodiments, communication interface 301 may receive, from subscribers, a plurality of requests for subscribing to a same set of transcribed texts, and time points for each of the requests may be determined and recorded. Distribution interface 307 may respectively distribute to each of the subscribers a subset of transcribed texts corresponding to the time points. It is contemplated that, distribution interface 307 may distribute the transcribed texts to the subscriber directly or via communication interface 301.

The subset of the transcribed texts corresponding to the time point may include a subset of transcribed texts corresponding to content of the audio signal from the start to the time point, or a subset of transcribed texts corresponding to a preset period of content of the audio signal. For example, a subscriber may be connected to speech recognition system 100, and send a request for subscribing to a phone call at a time point which is two minutes after the phone call has begun. Distribution interface 307 may distribute to the subscriber (e.g., first user 105a, second user 105b and/or text processing device 105c in FIG. 1) a subset of texts corresponding to all the content during the two minutes from the start of the phone call, or a subset of texts corresponding to only a predetermined period before the time point (for example, 10 seconds of content before the time point). It is contemplated that, the subset of texts may also correspond to a speech segment that is mostly recent to the time point.

In some embodiments, additional distribution may be made after subscription. For example, after the subset of texts is distributed to the subscriber in accordance to the request received when the audio signal is subscribed for the first time, distribution interface 307 may continue to distribute the transcribed texts to the subscriber. In one embodiment, communication interface 301 may not distribute additional texts until it receives, from the subscriber, a second request for updating the transcribed texts of the audio signal. Communication interface 301 may then distribute to the subscriber the most recently transcribed texts according to the second request. For example, the subscriber may click a refresh button displayed by the Graphic User Interface (GUI) to send the second request to communication interface 301, and distribution interface 307 may determine if there is any newly transcribed text and send the newly transcribed text to the subscriber. In another embodiment, distribution interface 307 may automatically push the most recently transcribed texts to the subscriber.

After the transcribed texts are received, the subscriber may further process the texts and extract information associated with the texts. As discussed above, the subscriber may be a text processing device 105c of FIG. 1, and text processing device 105c may include a processor executing instructions to automatically analyze the transcribed texts.

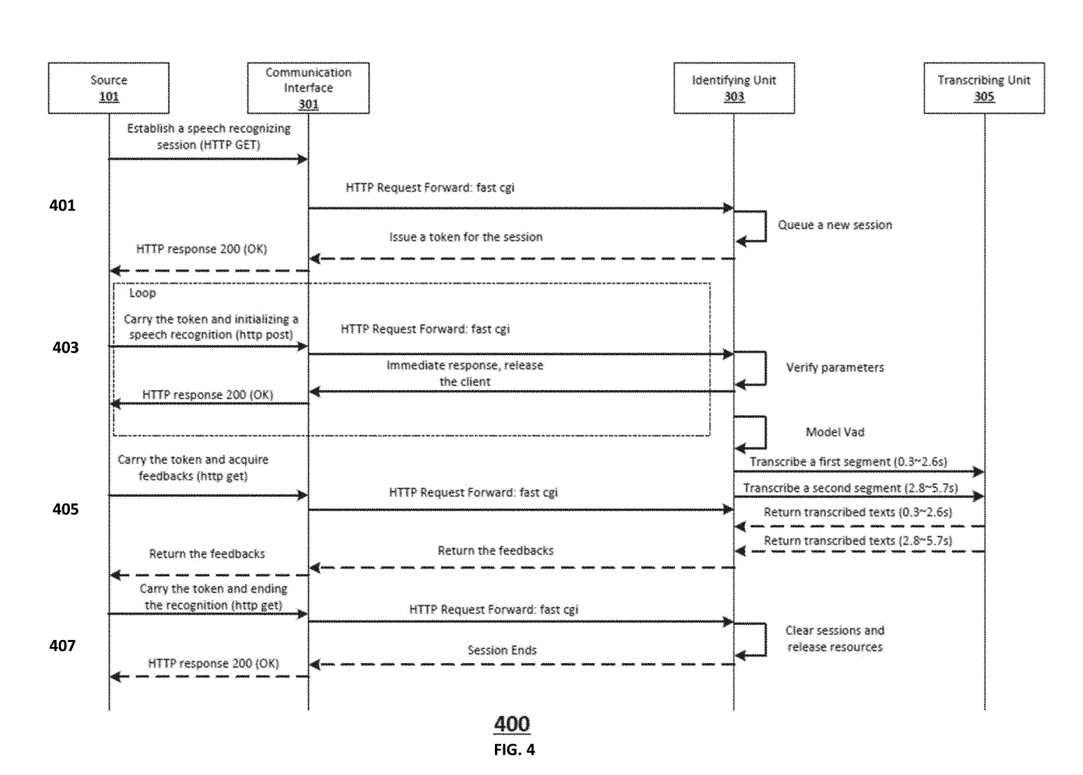

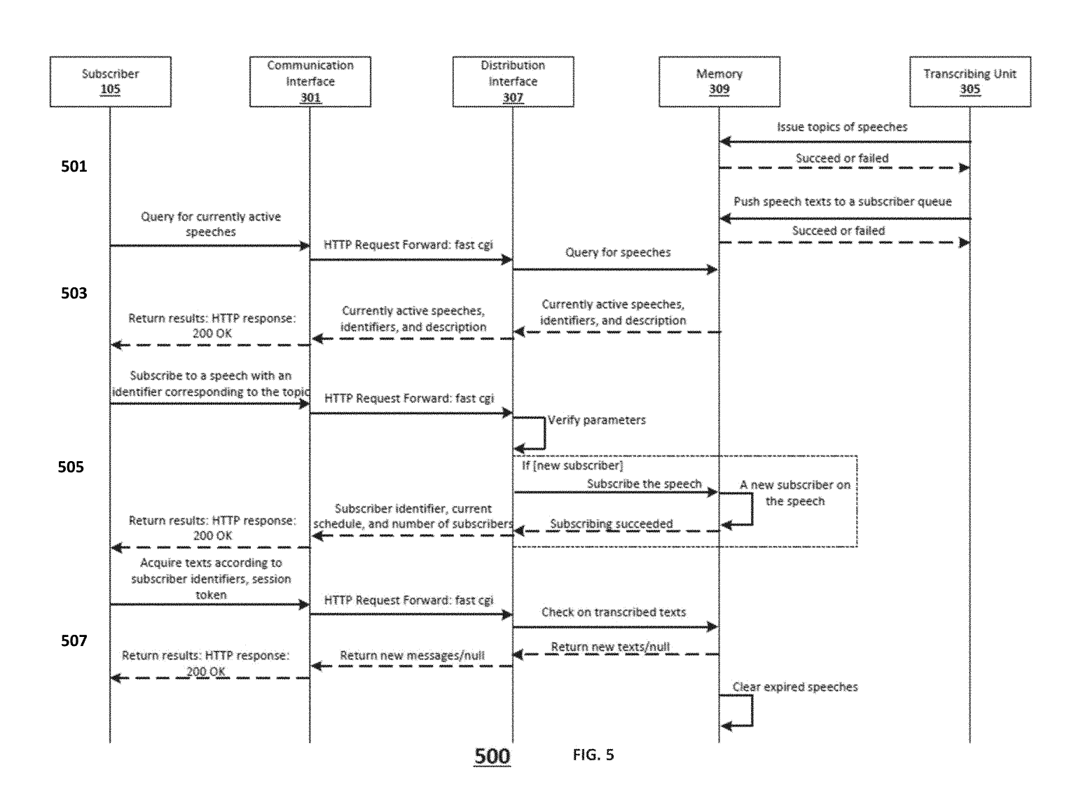

Processes for transcribing an audio signal into texts and distributing the transcribed texts according to the HyperText Transfer Protocol (HTTP) will be further described with reference to FIGS. 4 and 5.

FIG. 4 is a flowchart of an exemplary process 400 for transcribing an audio signal into texts, according to some embodiments of the disclosure. Process 400 may be implemented by speech recognition system 100 to transcribe the audio signal.

In phase 401, speech source 101 (e.g., SDK of an application on a smart phone) may send a request for establishing a speech session to communication interface 301 of speech recognition system 100. For example, the session may be established according to the HTTP, and accordingly, the request may be sent by, for example, a “HTTP GET” command. Communication interface 301, which receives the “HTTP GET” request, may be an HTTP Reverse Proxy, for example. The reverse proxy may retrieve resources from other units of speech recognition system 100 and return the resources to speech source 101 as if the resources originated from the reverse proxy itself. Communication interface 301 then may forward the request to identifying unit 303 via, for example, Fast CGI. Fast CGI is a protocol for interfacing programs with a server. It is contemplated that other suitable protocol may be used for forwarding the request. After the request for establishing the session is received, identifying unit 303 may generate, in memory 309, a queue for the session, and a token for indicating the session is established for communication interface 301. In some embodiments, the token may be generated by the UUID, and is a globally unique identity for the whole process described herein. After communication interface 301 receives the token, an HTTP response 200 (“OK”) is sent to source 101 indicating the session has been established. HTTP response 200 indicates the request/command has been processed successfully.

After the session is established, the speech recognition will be initialized in phase 403. In phase 403, source 101 may send to communication interface 301 a command for initializing a speech recognition and a speech signal of the audio signal. The command may carry the token for indicating the session, and the speech signal may last more than a predetermine period (e.g., 160 milliseconds). The speech signal may contain an ID number, which is incremental for each of the incoming speech signals. The command and the speech signal may be sent by, for example, a “HTTP POST” command. Similarly, communication interface 301 may forward the command and the speech signal to identifying unit 303 via “Fast CGI”. Then, identifying unit 303 may check the token and verify parameters of the speech signal. The parameters may include a time point at which the speech signal is receive, the ID number, or the like. In some embodiments, the ID number of the speech signal, which is typically consecutive, may be verified to determine the packet loss rate. As discussed above, when the transmission of a speech signal is complete, the thread for transmitting the speech signal may be released. For example, when the received speech signal is verified, identifying unit 303 may notify communication interface 301, which may send HTTP response 200 to speech source 101 indicating the speech signal has been received and the corresponding thread may be released. Phase 403 may be performed in loops, so that all speech signals of the audio signal may be uploaded to speech recognition system 100.

While phase 403 is being performed in loops, phase 405 may process the uploaded audio signal without having to wait for the loops to end. In phase 405, identifying unit 303 may segment the received speech signals into speech segments. For example, as shown in FIG. 4, a first speech signal, which lasts for 0.3˜5.7 second and contains a non-speech section for 2.6˜2.8 second, may be segmented into a first set of speech segments using VAD, such as the ModelVAD technique. For example, the speech signal may be divided into a first segment for 0.3˜2.6 second and a second segment for 2.8˜5.7 second. The speech segments may be transcribed into texts. For example, the first and second segments may be transcribed into first and second sets of texts, and the first and second sets of texts are stored in the queue generated by identifying unit 303. All texts generated from an audio signal will be stored in a same queue that corresponds to the audio signal. The transcribed texts may be stored according to the time points at which they are received. The queue may be identified according to the token, which is uniquely generated by the UUID. Therefore, each audio signal has a unique queue for storing the transcribed texts. While transcribing unit 305 is working on the received speech signals, speech source 101 may send to communication interface 301 a command asking for feedback. The feedback may include information regarding, for example, the current length of the speech, the progress for transcribing the audio signal, packet loss rate of the audio signal, or the like. The information may be displayed to the speaker, so that the speaker may adjust the speech if needed. For example, if the progress for transcribing the speech falls behind the speech itself for a predetermined period, the speaker may be notified of the progress, so that he/she can adjust the speed of speech. The command may similarly carry the token for identifying the session, and communication interface 301 may forward the command to identifying unit 303. After the command is received, identifying unit 303 retrieves the feedback corresponding to the token, and send it to communication interface 301 and further to speech source 101.

In phase 407, a command for terminating the session may be issued from speech source 101. Similarly, the command, along with the token, is transmitted to identifying unit 303 via communication unit 301. Then, identifying unit 303 may clear the session and release resources for the session. A response indicating the session is terminated may be sent back to communication interface 301, which further generates an HTTP response 200 (“OK”) and sends it to speech source 101. In some other embodiments, the session may also be terminated when there is a high packet loss rate or is idle for a sufficiently long period. For instance, the session may be terminated if the packet loss rate is greater than 2% or the session is idle for 30 seconds, for example.

It is contemplated that, one or more of HTTP responses may be an error, rather than “OK.” Upon receiving an error indicating a specific procedure fails, the specific procedure may be repeated, or the session may be terminated and the error may be reported to the speaker and/or an administrator of speech recognition system 100.

FIG. 5 is a flowchart of an exemplary process 500 for distributing transcribed texts to a subscriber, according to some embodiments of the disclosure. Process 500 may be implemented by speech recognition system 100 for distributing transcribed texts according to the flow chart of FIG. 5.

In phase 501, because speech recognition system 100 may process multiple speeches simultaneously, a message queue may be established in memory 309 so that transcribing unit 305 may issue topics of the speeches to the message queue. And a subscriber queue for each of the topics may be also established in memory 309, so that the subscriber(s) of a specific topic may be listed in the respective subscriber queue, and speech texts may be pushed to the respective subscriber queue by transcribing unit 305. Memory 309 may return responses to transcribing unit 305, indicating whether topics of the speeches are successfully issued and/or the speech texts are successfully pushed.

In phase 503, subscriber 105 may send to communication interface 301 a request, querying for currently active speeches. As described above, the request may be sent to communication interface 301 by the “HTTP GET” command. And the request will be forwarded to distribution interface 307 by, for example, Fast CGI, and then distribution interface 307 may query for topics of the active speeches that are stored in the message queue of memory 309. Accordingly, memory 309 may return the topics of the currently active speeches, along with related information of the speeches, to subscriber 105 via communication interface 301. The related information may include, e.g., identifiers and description of the speeches. Communication interface 301 may also send an HTTP response 200 (“OK”) to subscriber 105.

In phase 505, the topics and related information of the currently active speeches may be displayed to subscriber 105, who may subscribe to a speech with an identifier. A request for subscribing to the speech may be sent to communication interface 301, and then forwarded to distribution interface 307. Distribution interface 307 may verify parameters of the request. For example, the parameters may include a check code, an identifier of subscriber 105, the identifier of the speech, the topic of the speech, a time point at which subscriber 105 sends the request, or the like.

If distribution unit 307 determines subscriber 105 is a new subscriber, the speech corresponding to the request may be subscribed and subscriber 105 may be updated into the subscriber queue of memory 309. Then a response indicating the subscribing succeeded may be sent to distribution interface 307, which transmits to communication interface 301 information regarding the speech, such as an identifier of the subscriber, a current schedule of the speech, and/or the number of subscribers to the speech. Communication interface 301 may generate an HTTP response 200 (“OK”), and send the above information along with the HTTP response back to subscriber 105.

If distribution unit 307 determines subscriber 105 is an existing subscriber, distribution interface 307 may directly transmit the information to communication interface 301.

In phase 507, after HTTP response 200 (“OK”) is received by subscriber 105, subscriber 105 sends a request for acquiring texts according to, for example, the identifier of the subscriber, the token of the session, and/or the current schedule of the speech. The request may be forwarded to distribution interface 307 via communication interface 301 by Fast CGI, so that distribution interface 307 can access transcribed texts. Distribution interface 307 may transmit any new transcribed texts back to source 105, or a “Null” signal if there is no new text.

It is contemplated that, most recently transcribed texts may also be pushed to subscriber 105 automatically, without any request.

In some embodiments, if a topic of a speech stored in the message queue has not been inquired for a predetermined time period, the topic may be cleared as an expired one.

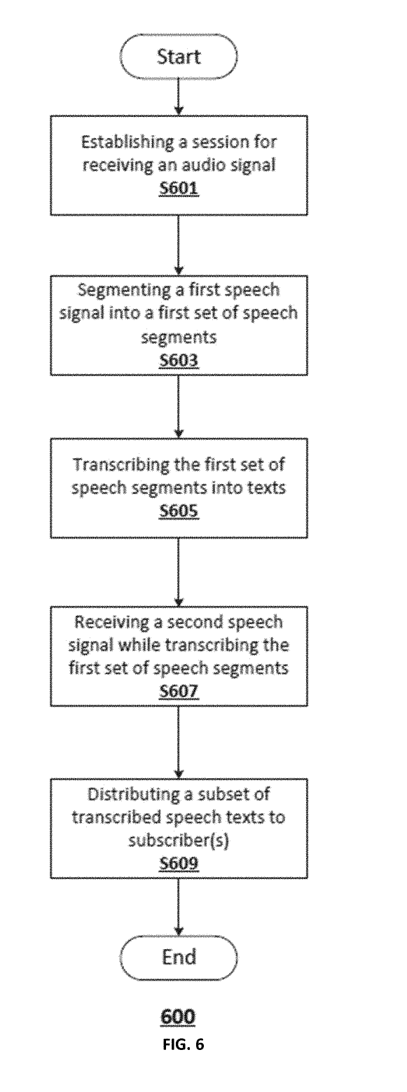

FIG. 6 is a flowchart of an exemplary process 600 for transcribing an audio signal into texts, according to some embodiments of the disclosure. For example, process 600 may be performed by speech recognition system 100, and may include steps S601-S609 discussed as below.

In step S601, speech recognition system 100 may establish a session for receiving the audio signal. The audio signal may include a first speech signal and a second speech signal. For example, the first speech signal may be received first according to Media Resource Control Protocol Version 2 or HyperText Transfer Protocol. Speech recognition system 100 may further monitor a packet loss rate for receiving the audio signal, and terminate the session when the packet loss rate is greater than a predetermined threshold. In some embodiments, when the packet loss rate is greater than 2%, the session is deemed unstable and may be terminated. Speech recognition system 100 may also terminate the session after the session is idle for a predetermined time period. For example, after the session is idle for 30 seconds, speech recognition system 100 may deem that the speech is over and terminate the session.

In step S603, speech recognition system 100 may segment the received first speech signal into a first set of speech segments. In some embodiments, VAD may be utilized to further segment the first speech signal into speech segments.

In step S605, speech recognition system 100 may transcribe the first set of speech segments into a first set of texts. In some embodiments, ASR may be used to transcribe the speech segments, so that the first speech signal may be stored and further processed as texts. An identity of the speaker may be also identified if previous speeches of the same speaker have been stored in the database of the system. The identity of the speaker (e.g., a user of an online hailing platform) may be further utilized to acquire information associated with the user, such as his/her preference, historical orders, frequently-used destinations, or the like, which may improve efficiency of the platform.

In step S607, while the first set of speech segments are being transcribed into the first set of texts, speech recognition system 100 may further receive the second speech signal. In some embodiments, the first speech signal is received through a first thread established during the session. After the first speech signal is segmented into the first set of speech segments, a response for releasing the first thread may be sent while the first set of speech segments are being transcribed. A second thread for receiving the second speech signal may be established once the first thread is released. By transcribing one speech signal and receiving the next signal in parallel, an audio signal may be transcribed into texts in real time. Similarly, speech recognition system 100 may segment the second speech signal into a second set of speech segments, and then transcribe the second set of speech segments into a second set of texts. Speech recognition system 100 may further combine the first and second sets of texts in sequence and store the combined texts as an addition to the transcribed texts in an internal memory or an external storage device. Thus, the whole audio signal may be transcribed into texts.

Speech recognition system 100 may provide further processing or analysis of the transcribed texts. For example, speech recognition system 100 may identify key words in the transcribed texts, highlight the key words, and/or provide extra information associated with the key words. In some embodiments, the audio signal is generated from a phone call to an online hailing platform, and when key words for a departure location and a destination location of a trip are detected in the transcribed texts, possible routes of the trip and time for each route may be provided.

In step S609, speech recognition system 100 may distribute a subset of transcribed texts to a subscriber. For example, speech recognition system 100 may receive, from the subscriber, a first request for subscribing to the transcribed texts of the audio signal, determine a time point at which the first request is received, and distribute to the subscriber a subset of the transcribed texts corresponding to the time point. Speech recognition system 100 may further receive, from the subscriber, a second request for updating the transcribed texts of the audio signal, and distribute, to the subscriber, the most recently transcribed texts according to the second request. In some embodiments, the most recently transcribed texts may also be pushed to the subscriber automatically. In some embodiments, the additional analysis of the transcribed texts described above (e.g., key words, highlights, extra information) may also be distributed to the subscriber.

In some embodiments, the subscriber may be a computation device, which may include a processor executing instructions to automatically analyze the transcribed texts. Various text analysis or processing tools can be used to determine the content of the speech. In some embodiments, the subscriber may further translate the texts to a different language. Analyzing texts are typically less computational and thus much faster than analyzing an audio signal directly.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed spoofing detection system and related methods. Other embodiments will be apparent to those skilled in the art from consideration of the specification and practice of the disclosed spoofing detection system and related methods. Although the embodiments are described using an online hailing platform as an example, the described real-time transcription systems and methods can be applied to transcribe audio signals generated in any other context. For example, the described systems and methods may be used to transcribe lyrics, radio/TV broadcasts, presentations, voice messages, conversations, etc.

It is intended that the specification and examples be considered as exemplary only, with a true scope being indicated by the following claims and their equivalents.

What is claimed is:

1. A method for transcribing an audio signal into texts, wherein the audio signal contains a first speech signal and a second speech signal, the method comprising:
establishing a session for receiving the audio signal;
receiving the first speech signal through the established session;
segmenting the first speech signal into a first set of speech segments;
transcribing the first set of speech segments into a first set of texts; and
receiving the second speech signal through the established session while the first set of speech segments are being transcribed.

2. The method of claim 1, further comprising:
segmenting the second speech signal into a second set of speech segments, and
transcribing the second set of speech segments into a second set of texts.

3. The method of claim 2, further comprising combining the first and second sets of texts in sequence and storing the combined texts as an addition to the transcribed texts.

4. The method of claim 1, further comprising:
receiving, from a subscriber, a first request for subscribing to the transcribed texts of the audio signal;
determining a time point at which the first request is received; and
distributing to the subscriber a subset of the transcribed texts corresponding to the time point.

5. The method of claim 4, further comprising:
further receiving, from the subscriber, a second request for updating the transcribed texts of the audio signal;
distributing, to the subscriber, the most recently transcribed texts according to the second request.

6. The method of claim 4, further comprising:
automatically pushing the most recently transcribed texts to the subscriber.

7. The method of claim 1, wherein establishing the session for receiving the audio signal further comprises:
receiving the audio signal according to Media Resource Control Protocol Version 2 or HyperText Transfer Protocol.

8. The method of claim 1, further comprising:
monitoring a packet loss rate for receiving the audio signal; and
terminating the session when the packet loss rate is greater than a predetermined threshold.

9. The method of claim 1, further comprising:
after the session is idle for a predetermined time period, terminating the session.

10. The method of claim 4, wherein the subscriber comprises a processor executing instructions to automatically analyze the transcribed texts.

11. The method of claim 1, wherein the first speech signal is received through a first thread established during the session, wherein the method further comprises:
sending a response for releasing the first thread while the first set of speech segments are being transcribed; and
establishing a second thread for receiving the second speech signal.

12. A speech recognition system for transcribing an audio signal into speech texts, wherein the audio signal contains a first speech signal and a second speech signal, the speech recognition system comprising:
a communication interface configured for establishing a session for receiving the audio signal and receiving the first speech signal through the established session;
a segmenting unit configured for segmenting the first speech signal into a first set of speech segments; and
a transcribing unit configured for transcribing the first set of speech segments into a first set of texts, wherein
the communication interface is further configured for receiving the second speech signal while the first set of speech segments are being transcribed.

13. The speech recognition system of claim 12, wherein
the segmenting unit is further configured for segmenting the second speech signal into a second set of speech segments, and
the transcribing unit is further configured for transcribing the second set of speech segments into a second set of texts.

14. The speech recognition system of claim 13, further comprising:
a memory configured for combining the first and second sets of texts in sequence and storing the combined texts as an addition to the transcribed texts.

15. The speech recognition system of claim 12, further comprising a distribution interface, wherein
the communication interface is further configured for receiving, from a subscriber, a first request for subscribing to the transcribed texts of the audio signal, and determining a time point at which the first request is received; and
the distribution interface is configured for distributing to the subscriber a subset of the transcribed texts corresponding to the time point.

16. The speech recognition system of claim 12, wherein the communication interface is further configured for monitoring a packet loss rate for receiving the audio signal; and terminating the session when the packet loss rate is greater than a predetermined threshold.

17. The speech recognition system of claim 12, wherein the communication interface is further configured for, after the session is idle for a predetermined time period, terminating the session.

18. The speech recognition system of claim 15, wherein the subscriber comprises a processor executing instructions to automatically analyze the transcribed texts.

19. The speech recognition system of claim 12, wherein the first speech signal is received through a first thread established during the session, and the communication interface is further configured for:
sending a response for releasing the first thread while the first set of speech segments are being transcribed; and
establishing a second thread for receiving the second speech signal.

20. A non-transitory computer-readable medium that stores a set of instructions, when executed by at least one processor of a speech recognition system, cause the speech recognition system to perform a method for transcribing an audio signal into texts, wherein the audio signal contains a first speech signal and a second speech signal, the method comprising:
establishing a session for receiving the audio signal;
receiving the first speech signal through the established session;
segmenting the first speech signal into a first set of speech segments;
transcribing the first set of speech segments into a first set of texts; and
receiving the second speech signal while the first set of speech segments are being transcribed.
